(19) United States
(12) Patent Application Publication
(10) Pub. No.: US 2025/0222810 A1
(43) Pub. Date: Jul. 10, 2025

(54) SYSTEM AND METHOD FOR SUPERCHARGING ELECTRIC VEHICLES

(71) Applicant: Electronic Power Design, Inc., Houston, TX (US)

(72) Inventor: JOHN BRADFORD JANIK, Houston, TX (US)

(73) Assignee: Electronic Power Design, Inc., Houston, TX (US)

(21) Appl. No.: 19/010,381

(22) Filed: Jan. 6, 2025

Related U.S. Application Data
(60) Provisional application No. 63/618,409, filed on Jan. 8, 2024.

(51) Int. Cl. B60L 53/62; H02J 3/01; H02M 1/00; H02M 7/04

(52) U.S. Cl. CPC B60L 53/62; H02J 3/01; H02M 1/0043; H02M 7/04

(57) ABSTRACT

A system provides 6-pulse DC drives to generate a 54 pulse DC drive. These drives are used to control the power supplied to electric vehicles during the supercharging process. 6-pulse DC drives are known for their efficiency and reliability in converting AC power to DC, which is essential for charging electric vehicles. the 6-pulse DC drives, a phase-shifting transformer is employed in the system. This transformer serves the purpose of creating pseudo 54 pulse drives for the supercharging process. The phase-shifting mechanism significantly contributes to the reduction of harmonics and noise generation during the charging process. This invention provides a method and apparatus for powering ten electric vehicle charging stations by integrating ten 6-pulse SCR systems with phase-shifting angles of 6° increments, achieving a pseudo-54-pulse waveform. The approach improves harmonic cancellation, reduces total harmonic distortion (THD), and ensures stable power delivery.

### CROSS REFERENCE TO RELATED APPLICATIONS

This patent application claims priority from U.S. provisional patent application Ser. No. 63/618,409 by Janik entitled A SYSTEM AND METHOD FOR SUPERCHARGING ELECTRIC VEHICLES filed on Jan. 8, 2024

### BACKGROUND OF THE INVENTION

Electric vehicles are proliferating along with the need to charge electric vehicles.

### FIELD OF THE INVENTION

The present invention relates to the field of electric vehicle charging.

### BRIEF DESCRIPTION OF THE DRAWINGS

FIG. 1 depicts a particular illustrative embodiment of the invention.

The drawings presented herein are for illustrative purposes only and do not limit the scope of the claims. Rather, the drawings are intended to help enable one having ordinary skill in the art to make and use the claimed inventions.

### SUMMARY OF THE INVENTION

The system provides 6-pulse DC drives to generate a 54 pulse DC drive. These drives are used to control the power supplied to electric vehicles during the supercharging process. 6-pulse DC drives are known for their efficiency and reliability in converting AC power to DC, which is essential for charging electric vehicles. the 6-pulse DC drives, a phase-shifting transformer is employed in the system. This transformer serves the purpose of creating pseudo 54 pulse drives for the supercharging process. The phase-shifting mechanism significantly contributes to the reduction of harmonics and noise generation during the charging process. This invention provides a method and apparatus for powering ten electric vehicle charging stations by integrating ten 6-pulse SCR systems with phase-shifting angles of 6° increments, achieving a pseudo-54-pulse waveform. The approach improves harmonic cancellation, reduces total harmonic distortion (THD), and ensures stable power delivery.

### DETAILED DESCRIPTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details, nor do they limit the scope of the claims.

In an illustrative embodiment of the invention, a system and method utilize phase-shifting transformers to introduce precise 6° shifts between each SCR system; control circuitry to synchronize and manage the operation of the 6-pulse rectifiers; and load management systems to ensure balanced power distribution across all charging stations.

The invention offers a cost-effective, scalable solution to enhance the performance and efficiency of EV charging infrastructure. In an illustrative embodiment of the system provides ten 6-pulse SCR rectifiers that are connected to the grid via phase-shifting transformers; phase-shifting angles: Each SCR system operates with a distinct phase shift to generate the pseudo-54-pulse waveform. Phase angles are calculated as (n×36 degrees)(n \times 36\hat{ }\circ)(n×36 degrees), where n is the sequence number of the SCR system, ensuring harmonic cancellation. In another embodiment of the invention each rectifier operates with a phase shift of n×6 degrees n \times 6\hat{ }circn×6 degrees, where n is the rectifier sequence (e.g., 0 degrees, 6 degrees, 12 degrees, 18, 24 degrees, 30 degrees, 36 degrees, 42 degrees, 48 degrees and 54 degrees for each of the phase shifts respectively). Output filters provide additional harmonic suppression as needed.

In another particular embodiment, Phase-shifting angles: Each SCR system operates with a distinct phase shift to generate the pseudo-54-pulse waveform. Phase angles are calculated as (n×36 degrees)(n \times 36\hat{ }\circ)(n×36 degrees), where n is the sequence number of the SCR system, ensuring harmonic cancellation.

Benefits of the invention include but are not limited to enhanced power quality: The pseudo-54-pulse waveform significantly reduces harmonic distortion, improving grid compatibility. Cost-effectiveness: The system leverages standard 6-pulse SCR technology with minimal modifications, reducing implementation costs. Scalability: Additional 6-pulse SCR rectifiers can be added with appropriate phase-shifting to extend the system's capacity.

Utilization of 6-pulse DC Drives: The system employs ten 6-pulse DC drives as a fundamental component of its operation. These ten 6-pulse DC drives are used to control the power supplied to electric vehicles during the supercharging process. 6-pulse DC drives are known for their efficiency and reliability in converting AC power to DC, which is essential for charging electric vehicles.

Deployment of Phase-Shifting Transformers 110: In conjunction with the 6-pulse DC drives, phase-shifting transformers are employed in the system. The phase shifting transformers create a pseudo 54 pulse drive for the supercharging process. The phase-shifting mechanism significantly contributes to the reduction of harmonics and noise generation that feed back into the electrical grid during the electrical vehicle super charging process. Each phase shifting transformer has an input connected to the electrical grid and an output connected to one of the electric vehicle charging stations. By varying the phase shift, the transformer can either increase or decrease the power flow on a line depending on the desired outcome.

This phase shift for the phase shifting transfer is achieved by using a tap changer on a regulating winding within the phase shifting transformer, allowing for discrete adjustments to the phase angle for the phase shifting transformer. In another embodiment, the phase shifting transformers are programmable so that a controller adjusts the phase angle in the phase shifting transformer. In another embodiment, the phase is performed by an SCR. In a particular embodiment of the invention, the SCRs are programmable so that a controller adjusts the phase angle in the phase shift of the SCR.

Reduction of Harmonics and Noise: One of the primary goals of this system is to minimize harmonics and noise generated during supercharging. The use of a phase-shifting transformer is instrumental in achieving this objective, as it effectively transforms the 6-pulse DC drive power supply into a 54-pulse DC drive configuration. Reducing harmonics and noise that feed back into the electrical utility power grid is important to ensure the stability of the electrical power grid and prevent disruption to other connected devices.

Phase-Shifted 6-Pulse SCR Drives: In another embodiment of the invention, the system features phase-shifted 6-pulse SCR (Silicon-Controlled Rectifier) drives. These 6-pulse SCR drives play a crucial role in controlling the power output during the charging process. Through phase shifting, the system creates a 60-pulse drive for each station charging, especially designed to cater to high-power demands (e.g., 10 electric vehicles with a combined power requirement of 1 megawatt).

Harmonic Reduction and Grid Stability: By using phase-shifting technology to create a pseudo 54-pulse and 60-pulse drive, the system ensures that the first harmonic is at the 53rd and 59th harmonic of the power waveform, respectively. This positioning of the first harmonic results in a much lower amplitude compared to a 6-pulse drive, which is a significant advantage for grid stability. Minimizing harmonics and reducing the amplitude of higher-order harmonics helps in maintaining a more stable and clean power supply to electric vehicles and the grid.

High Power Charging Stations: The system is designed to cater to high-power charging stations capable of delivering 1 megawatt of power to a group of electric vehicles. This feature is important for rapidly charging multiple EVs simultaneously, making it suitable for applications such as fast-charging hubs and commercial charging stations.

The system for providing supercharging to electric vehicles is designed to enhance efficiency, reduce harmonics, and ensure grid stability during the charging process. It achieves these goals through the use of 6-pulse DC drives, a phase-shifting transformer, and phase-shifted SCR drives, ultimately delivering clean and high-power charging for electric vehicles.

This approach offers a cost-effective electric vehicle (EV) charging system that minimizes electrical grid pollution by avoiding noise and harmonics generated by ten 6-pulse drives operating at 1 megawatt.

The number of pulses used for charging correlates with the quantity of EVs being serviced. For instance, one vehicle uses 6-pulses, while two vehicles use 12 pulses, and ten vehicles use 54 pulses, and so forth.

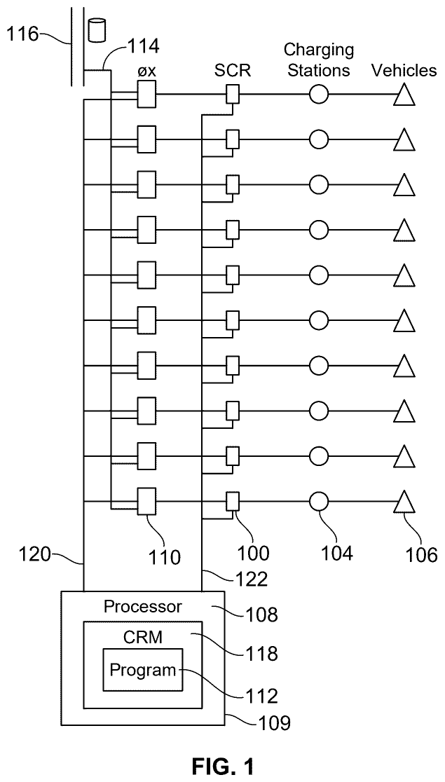

Turning now to FIG. 1, in a particular illustrative embodiment of the invention ten 6-pulse silicon controlled rectifier DC drives 100 are electrically connected to ten electric vehicle charging stations 104 charging ten vehicles 106. An output from each of the ten is electrically connected to a phase shifting transformer 110. The output of each of the ten 6-pulse silicon controlled rectifier DC drives is phase shifted from the output of each of the other silicon controlled rectifier DC drives so that a pseudo multi-pulse is produced resulting in less noise and harmonics on the electrical grid during charging of electrical vehicles connected to the ten electrical vehicle charging stations. In an illustrative embodiment of the invention, phase-shifting implementation: Each 6-pulse SCR rectifier connects through a phase-shifting transformer introducing a unique phase shift in increments of 6°. Harmonic Cancellation: By combining the outputs of all ten phase-shifted rectifiers, the system synthesizes a waveform equivalent to a 54-pulse system, significantly reducing harmonic content. Power Distribution: The aggregate output powers ten EV charging stations 104, ensuring efficient and uniform power delivery. Control and Synchronization: In another illustrative embodiment of the invention, digital controllers 108 monitor and adjust SCR firing angles (phase shift for each SCR output) in real time, during vehicle charging, ensuring harmonic minimization and optimal power quality. The digital controllers 109 each have a processor 108, non-transitory computer readable medium 118 having a computer program 112 stored on the non-transitory computer readable medium. Three phase power 114 is provided by an electrical utility grid 116 that provides power to the ten phase shifting transformers 110. The power output through each of the phase shifting transformers is phase shifted relative to each other phase shifting transformer 110 so that the utility grid effective receives the electrical effects of a much higher pulse SCR power supply, in the example case, a 54-pulse rather than a 6-pulse SCR power supply.

A digitally controlled phase-shifting three-phase electrical transformer is a specialized device used in power systems to control the phase angle of voltages in a three-phase electrical network. This type of transformer combines conventional electrical phase-shifting techniques with digital control systems, offering precise and flexible control of power flow in electrical grids. Below are the key components, principles, and applications of such a device:

Key Components: Phase-Shifting Transformer (PST): A conventional transformer design that alters the phase angle of the voltage between the input and output terminals. Achieved using series and shunt transformers, interconnected in specific configurations. Digital Control System: A microcontroller, FPGA, or PLC-based system that controls the phase shift dynamically. Uses feedback from sensors measuring voltage, current, and phase angle in real-time. Power Electronics: Solid-state devices such as Insulated Gate Bipolar Transistors (IGBTs) or Thyristors may be used to fine-tune phase shifts or enable fast switching. Can be used in conjunction with the transformer for dynamic phase adjustment. Sensors and Feedback Loops: Voltage, current, and phase angle sensors provide real-time data to the control system. Enable closed-loop control for accuracy and stability.

Working Principle. A phase-shifting transformer creates a phase angle difference between the input and output voltages by adding or subtracting a phase-shifted voltage to the main line voltage. The digital control system adjusts the phase shift by controlling tap changers (mechanical or electronic) or modifying parameters of the power electronics. By altering the phase angle, the device can control power flow between interconnected networks or improve load sharing between parallel systems.

Features of Digital Control. Precision: Digital control enables precise phase angle adjustment to meet system demands. Automation: Automated control algorithms adapt to changing grid conditions without manual intervention. Flexibility: Can be integrated with SCADA systems or other grid management platforms.

Dynamic Operation: Enables real-time adjustments to phase angle of power supplied to individual electric vehicle charging stations and SCRs that power electric vehicle charging stations, power flows, critical in systems with renewable energy sources.

Improves the voltage profile of the system by dynamically adjusting phase shifts. HVDC Integration: Used in hybrid AC/DC grids to facilitate power transfer and phase synchronization.

Advantages Enhanced grid stability and reliability; Efficient power flow management without requiring major grid upgrades. Compatibility with modern digital grid infrastructure.

A digitally controlled phase-shifting system using Silicon Controlled Rectifiers (SCRs) is a technique used to control the phase angle and voltage output in AC systems. This system is commonly applied in industrial motor control, AC-DC converters, and power flow control in power systems. Below are the details:

Key Components Silicon Controlled Rectifiers (SCRs): Semiconductor devices used to control the conduction angle of AC waveforms. Operated by applying a gate pulse to control when they turn on during each AC cycle. Digital Controller: A microcontroller, DSP, or FPGA provides precise timing signals for the gate pulses. Calculates the desired phase angle based on input parameters or feedback. Voltage and Current Sensors: Measure system variables like output voltage, load current, and phase angle. Provide feedback to the digital controller for closed-loop control. Trigger Circuit: Interfaces between the digital controller and the SCRs. Ensures proper synchronization with the AC waveform. Load: Typically an AC motor, heating element, or another device requiring variable phase control.

Working Principle. The SCRs are connected in a bridge or phase-shifting circuit to control the output waveform. The digital controller calculates the phase angle shift required to achieve a specific output. Gate pulses are generated at precise times during each AC cycle, controlling when each SCR begins conduction. By varying the conduction angle of the SCRs, the phase of the output voltage is shifted, or the output voltage magnitude is modulated.

Control Features Phase Control: The SCRs can delay conduction to achieve the desired phase shift or voltage control. Digital Precision: Digital controllers provide accurate timing for gate signals, allowing fine-tuned adjustments. Feedback Integration: Real-time feedback ensures the system adapts to changes in load or input conditions.

Applications. AC Motor Drives: Controls the speed of AC motors by adjusting voltage and phase. HVDC Systems: SCRs function as converters to control power flow between AC and DC networks. Power Factor Correction: Phase shifting helps balance reactive power in electrical systems.

Advantages. High efficiency due to SCR's low on-state voltage drop. Digital control allows for programmable and adaptive operation. Versatile for a wide range of power and industrial applications.

Technical Schematic Key Connections: SCR Configuration: Typically arranged in a bridge for three-phase applications. Trigger Circuit: Provides synchronized firing pulses to each SCR based on digital control inputs. Feedback Loop: Monitors output voltage and current to adjust SCR firing angles dynamically.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom. Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that is issued therefrom.

1. A method of generating a pseudo-54-pulse waveform using ten 6-pulse SCR rectifiers, each operating with a unique phase shift in 6° increments, to power electric vehicle charging stations with reduced harmonic distortion on an electrical grid.

2. The method of claim 1, wherein the phase shifts are performed by a plurality of phase shifting transformers.

3. The method of claim 2, wherein the phase shifts are performed by a controller.

4. The method of claim 1, wherein the unique phase shifts are phase shifts of 0 degrees, 6 degrees, 12 degrees, 18 degrees, 24 degrees, 30 degrees, 36 degrees, 42 degrees, 48 degrees and 54 degrees, respectively.

5. The method of claim 1, further comprising:
adjusting SCR phase shifts using a controller, in real time during vehicle charging, reducing harmonics on the electrical grid.

6. An electric vehicle charging system, the system comprising:
an electrical grid, a plurality of phase shifting transformers;
an input on each of the plurality of phase shifting transformers;
an input on each of the plurality of phase shifting transformers, wherein each input is connected to the electrical grid, wherein an output of each of the plurality of phase shifting transformers is phase shifted from each output of the plurality of phase shifting transformers;
a plurality of electric vehicle charging stations, wherein the output of each plurality of 6-pulse DC drives is electrically connected to an input of one of the plurality of electric vehicle charging stations; and
wherein the phase shifting transformer electrically connected to the input of each of the plurality of 6-pulse DC drives.

7. The electric vehicle charging system of claim 6, wherein the output during charging at the electric vehicle charging station is a pseudo multiple pulse DC output is a multiple of 6 pulses wherein the phase shifts for the phase shifting transformers are phase shifts of 0 degrees, 6 degrees, 12 degrees, 18 degrees, 24 degrees, 30 degrees, 36 degrees, 42 degrees, 48 degrees and 54 degrees respectively.

8. The electric vehicle charging system of claim 6, wherein the phase shifting transformer creates a pseudo multiple pulse DC output on by the electrical grid.

9. The electric vehicle charging station of claim 7, wherein the pseudo multiple pulse DC output is a multiple of 6 pulses.

10. The electric vehicle charging system of claim 6, wherein phase shifting transformers create a pseudo multiple pulse DC output is a 54-pulse DC output on by the electrical grid.

11. The electric vehicle charging system of claim 6, wherein phase shifting transformers creates a pseudo multiple pulse DC output is a 60-pulse DC output on by the electrical grid.

12. The electric vehicle charging system of claim 6, wherein the 6-pulse DC drive is a silicon-controlled rectifier.

13. The electric vehicle charging system of claim 7, wherein the pseudo multiple pulse DC outputs to the plurality of electric vehicle charging stations reduces harmonics on the electrical grid during electric vehicle charging.

14. The electric vehicle charging system of claim 7, wherein the pseudo multiple pulse DC outputs to the plurality of electric vehicle charging stations reduces noise on the electrical grid during electric vehicle charging.

15. An electric vehicle charging system, the system comprising:
an electrical grid;
a plurality of 6-pulse silicone controlled rectifiers electrically connected to the electrical grid; an output on each of the plurality of silicone controlled rectifiers;
a plurality of electric vehicle charging stations, wherein each of the plurality of electric vehicle charging stations is connected to only one of the plurality of silicone controlled rectifiers;
a controller that phase shifts each of the plurality of silicon controlled rectifier outputs wherein each of the plurality of outputs is phase shifted from each output of the plurality of silicon controlled rectifiers; and
a plurality of electric vehicle charging stations, wherein the output of each plurality of 6-pulse silicon controlled rectifiers is electrically connected to an input of one of the plurality of electric vehicle charging stations.

16. The system of claim 15, wherein the output during charging at the electric vehicle charging station

17. The electric vehicle charging system of claim 15, wherein the controller creates a pseudo multiple pulse DC output on by the electrical grid.

18. The electric vehicle charging system of claim 15, wherein the output is a multiple of 6 pulses.

19. The electric vehicle charging system of claim 15, wherein phase shifting creates a pseudo multiple pulse DC output is a pseudo 54-pulse DC output on by the electrical grid.

20. The electric vehicle charging system of claim 19 wherein the phase shifts are phase shifts of 0 degrees, 6 degrees, 12 degrees, 18 degrees, 24 degrees, 30 degrees, 36 degrees, 42 degrees, 48 degrees and 54 degrees, respectively.
